(19) United States
(12) Patent Application Publication
(10) Pub. No.: US 2010/0223213 A1
(43) Pub. Date: Sep. 2, 2010

(54) SYSTEM AND METHOD FOR PARALLELIZATION OF MACHINE LEARNING COMPUTING CODE

(75) Inventors: Jimmy Zhigang Su, Milpitas, CA (US); Archana Ganapathi, Palo Alto, CA (US); Mark Rotblat, Berkeley, CA (US)

Correspondence Address: PERKINS COIE LLP, P.O. BOX 1208, SEATTLE, WA, 98111-1208, US

(73) Assignee: Optillel Solutions, Inc., Milpitas, CA (US)

(21) Appl. No.: 12/395,480

(22) Filed: Feb. 27, 2009

(51) Int. Cl. G06F 15/18; G06F 9/38

(52) U.S. Cl. 706/12; 712/30; 712/205; 718/103; 712/E09.062

(57) ABSTRACT

Systems and methods for parallelization of machine learning computing code are described herein. In one aspect, embodiments of the present disclosure include a method of generating a plurality of instruction sets from machine learning computing code for parallel execution in a multi-processor environment, which may be implemented on a system, of, partitioning training data into two or more training data sets for performing machine learning, identifying a set of concurrently-executable tasks from the machine learning computing code, assigning the set of tasks to two or more of the computing elements in the multi-processor environment, and/or generating the plurality of instruction sets to be executed in the multi-processor environment to perform a set of processes represented by the machine learning computing code.

### FEDERALLY-SPONSORED RESEARCH

This disclosure was made with Government support under Proposal No. 07-2 A1.05-9348, awarded by The National Aeronautics and Space Administration (NASA), and agency of the United States Government. Accordingly, the United States Government may have certain rights in this disclosure pursuant to these grants.

### TECHNICAL FIELD

The present disclosure relates generally to parallel computing and is in particular related to parallel computing for machine learning.

### BACKGROUND

Traditionally, computing code is written for sequential execution in a system with a single processing element. Serial computing code typically includes instructions for sequential execution, one after another. With the execution of serial code by a single processing element, generally only one instruction is executed at one time. Therefore, a latter instruction usually cannot be processed until a previous instruction has been executed.

In contrast, parallel computing code can be executed concurrently. Parallel code execution operates principally based on the concept that algorithms can be broken down into instructions suitable for concurrent execution. Parallel computing is becoming a paradigm through which computing performance is enhanced, for example, through parallel computing in multi-processor environments of various architectures.

However, in parallel computing, a given algorithm or application generally needs to be rewritten in different versions for different types of hardware architectures. Having to tailor the source code for any given algorithm or application to different architectures becomes tedious for applications programmers and developers. This inhibits the ability of parallel computing code to be deployed in any platform without the burden of the developer to re-write code that is specific to the architecture in which the application is to be deployed.

### BRIEF DESCRIPTION OF THE DRAWINGS

FIG. 1 illustrates an example block diagram of an optimization system to automate parallelization of machine learning computing code, according to one embodiment.

FIG. 2 illustrates an example block diagram of processes performed by an optimization system during compile time and run time, according to one embodiment.

FIG. 3 illustrates an example block diagram of the synthesis module, according to one embodiment.

FIG. 4 depicts a flow chart illustrating an example process for generating instruction sets from a sequential program for parallel execution in a multi-processor environment, according to one embodiment.

FIG. 5 depicts a flow chart illustrating an example process for generating instruction sets using concurrently-executable tasks in machine learning computing code, according to one embodiment.

FIG. 6 depicts a flow chart illustrating an example process for generating instruction sets using pipelining stages and concurrently-executable tasks in machine learning computing code, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the invention. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for parallelization of machine learning computing code.

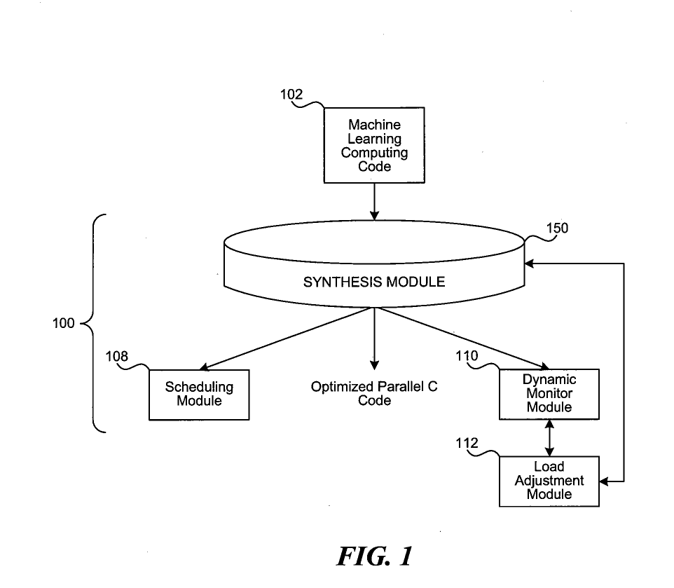

FIG. 1 illustrates an example block diagram of an optimization system 100 to automate parallelization of machine learning computing code 102, according to one embodiment.

The machine learning computing code 102 can be provided as an input to the optimization system 100 for parallelization. The machine learning code 102 is generally C-programming language based including but not limited to C++ programming language. The same technique can be similarly applied to other text based programming languages such as Java. The machine learning computing code 102, when executed, is able to perform processes including, but not limited to, data mining. Data mining can be performed for, for example, trend detection, topic extraction, and/or fault or anomaly detection, etc. In addition, data mining can further be used for inferring models from data, classification of instances or events, fusing multiple data sources, etc.

Data mining can be implemented using ensembles of decision trees (EDTs) for building and implementing diagnostic and prognostic models to perform feature-set reduction, classification, regression, clustering, and anomaly detection. In one embodiment, the machine learning computing code 102, when executed, is operable to perform fault detection for identifying faults, by way of example, but not limitation, in aircrafts or spacecrafts and further determining the lifecycle. Application in other additional industries is also contemplated, including but not limited to, chemical, pharmaceutical, manufacturing, and automotive for analysis of large multivariate datasets.

In one embodiment, the machine learning computing code 102 is suited for deployment in real-time or near real-time in multi-processor environments of various architectures such as multi-core chips, clusters, field-programmable gate arrays (FPGAs), digital signal processing chips, and/or graphical processing units (GPUs). To this end, the machine learning computing code 102 can be automatically parallelized for execution in a multi-processor environment including any number or combination of the above listed architecture types. The instruction sets suitable for parallel execution generated from the machine learning computing code 102 allows multiple threads of the machine learning computing code 102 to be executed concurrently by the various computing elements in the multi-processor environment.

The machine learning computing code 102 can be input to the optimization system 100 where the synthesis module 150 generates instruction sets for parallel execution by computing elements in the multi-processor environment. The instruction sets are typically generated based on the architecture of the multi-processor environment in which the instruction sets are to be executed.

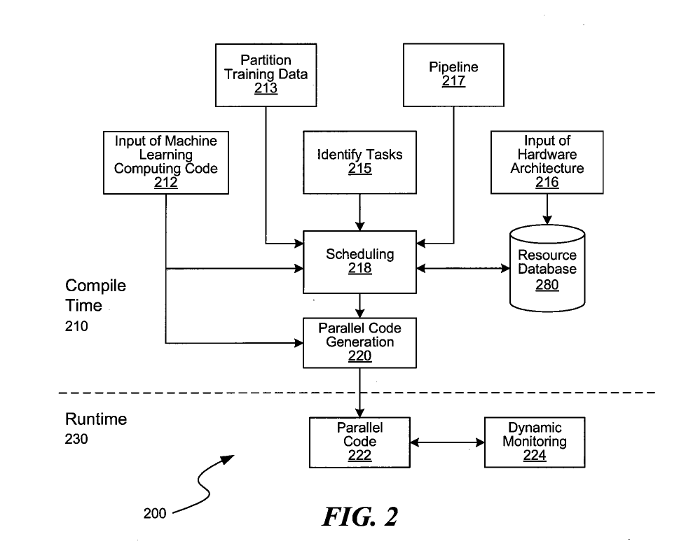

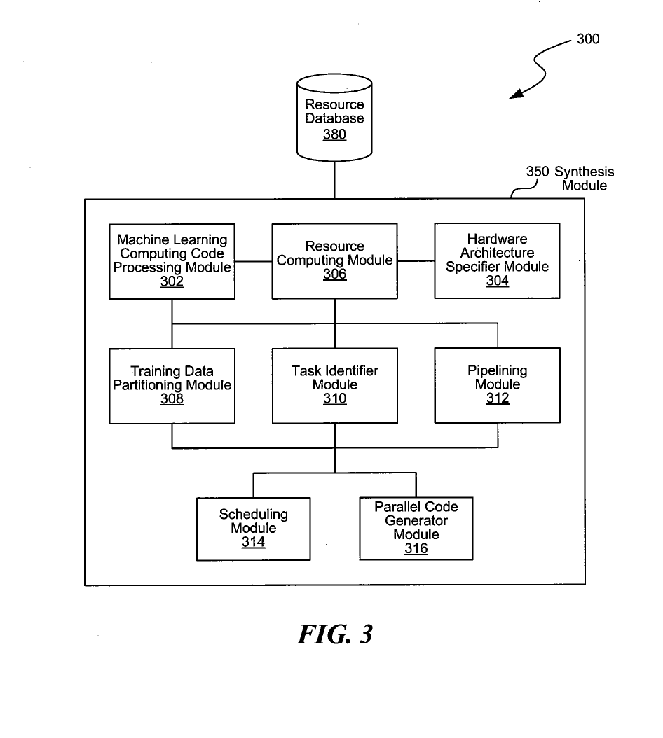

The optimization system 100 can include a synthesis module 150, a scheduling module 108, a dynamic monitor module 110, and/or a load adjustment module 112. Additional or fewer modules can be included without deviating from the novel art of this disclosure. In addition, each module in the example of FIG. 1 can include any number and combination of sub-modules, and systems, implemented with any combination of hardware and/or software modules. The optimization system 100 may be communicatively coupled to a resource database as illustrated in FIG. 2-3. In some embodiments, the resource database is partially or wholly internal to the synthesis module 150.

The optimization system 100, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In one embodiment, the machine learning computing code 102 is initially analyzed to identify training data, concurrently-executable tasks, and/or pipelining stages. For example, training data is supplied by the user as a collection of samples, then the data is partitioned into multiple training data sets such that machine learning can be performed concurrently on multiple computing elements. Concurrently-executable tasks can be identified by user annotations and each task can be assigned to various computing elements the multi-processor environment. Pipelining stages can also be identified by user annotations.

One embodiment of the optimization system 100 further includes a scheduling module 108. The scheduling module 208 can be any combination of software agents and/or hardware modules able to assign concurrently executable threads to the computing elements in the multi-processor environment. The scheduling module 208 can use the identified training data, concurrently-executable tasks, and/or pipelining stages for assignment to the computing elements based on the architecture and the available memory pathways that may be uni-directionally or bi-directionally accessible by the computing elements. Furthermore, the communication cost/delay between the computing elements can be determined by the scheduler control module 208 in assigning the threads to the computing elements in the multi-processor environment.

One embodiment of the optimization system 100 further includes the synthesis module 150. The synthesis module 150 can be any combination of software agents and/or hardware modules able to identify the threads from the machine learning computing code 102 suitable for parallel execution in the multi-processor environment. The threads can be executed in the multi-processor environment to perform the functions represented by the corresponding machine learning computing code 102.

In most instances, the architecture of the multi-processor environment is factored into the synthesis process for generation of the instructions for parallel execution. The architecture (e.g., type of multi-processor environment and the number of processors/cores) of the multi-processor environment can be user-specified or automatically detected by the optimization system 100. The type of architecture can affect the estimated running time for the threads and processes of the machine learning computing code.

Furthermore, the type of architecture determines the type of memory available to the processing elements. Memory allocation and communication costs between processing element and memory elements also affect the assignment of threads in the multi-processor environment. The communication delay between processors among a network and/or between processors and the memory bus in the multi-processor environment is factored into the thread assignment process and generation of instructions for parallel execution.

The synthesis module 150 can generate instructions for parallel execution that is optimized for the particular architecture of the multi-processor environment and based on the assignment of the threads to the computing elements as determined by the scheduling module 108. One embodiment of the optimization system 100 further includes the dynamic monitor module 110. The dynamic monitor module 110 can be any combination of software agents and/or hardware modules able to detect load imbalance among the computing elements in the multi-processor environment when executing the instructions/threads in parallel.

In some embodiments, during run-time, the computing elements in the multi-processor environment are dynamically monitored by the dynamic monitor module 110 to determine the time elapsed for executing each thread to identify the situations where the load on the available processors or memory is potentially unbalanced. In such a situation, assignment of the threads to computing elements may be readjusted, for example, by the load adjustment module 112.

FIG. 2 illustrates an example block diagram of processes performed by an optimization system during compile time and run time, according to one embodiment.

During compile time 210, the scheduling process 218 is performed with inputs of partitioned training data 213, identified tasks 215 that are concurrently-executable, and pipeline stages 217. The hardware architecture 216 of the multi-processor environment is also input to the scheduling process 218. The hardware architecture 216 provides information related to memory type, memory allocation (shared or local), memory size, types of processors, processor speed, cache size, cache speed, to the scheduling process 218.

In addition, data from the resource database 280 can be utilized during scheduling 218 for determining assignment of functional blocks to computing elements. The resource database 208 can store data related to running time of the threads and the communication delay and/or costs among processors or memory in the multi-processor environment.

After the scheduling process 218 has assigned the threads to the computing elements, the result of the assignment can be used for parallel code generation 220. The input of machine learning computing code 212 is also used in the parallel code generation process 210 during compile time 210. During runtime 230, the parallel code can be executed by the computing elements in the multi-processor environment while concurrently being optionally dynamically monitored 224 to detect any load imbalance among the computing elements by continuously or periodically tracking the number of running threads on each computing elements, memory usage level, and/or processor usage level.

FIG. 3 illustrates an example block diagram of the synthesis module 350, according to one embodiment.

One embodiment of the synthesis module 350 includes a machine learning computing code processing module 302, a hardware architecture specifier module 304, a resource computing module 306, a training data partitioning module 308, a task identifier module 310, a pipelining module 312, a scheduling module 314, and/or a parallel code generator module 316. The resource computing module 306 can be coupled to a resource database 380 that is internal or external to the synthesis module 350.

Additional or fewer modules can be included without deviating from the novel art of this disclosure. In addition, each module in the example of FIG. 3 can include any number and combination of sub-modules, and systems, implemented with any combination of hardware and/or software modules. The synthesis module 350 may be communicatively coupled to a resource database 380 as illustrated in FIG. 3A-B. In some embodiments, the resource database 380 is partially or wholly internal to the synthesis module 350.

The synthesis module 350, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the function represented by the modules can be implemented individually or in any combination thereof, partially or wholly, in hardware, software, or a combination of hardware and software.

One embodiment of the synthesis module 350 includes the machine learning computing code processing module 302 (“code processing module 302”). The machine learning computing code processing module 302 can be any combination of software agents and/or hardware modules able to process the machine learning computing code input to the code processing module 302 and retrieve user annotations.

The user annotations can be used to identify tasks that can be executed concurrently. User annotations can also be used to identify the stages in a pipeline. The synthesis tool utilizes that the annotations to generate code that distributes the task among different processing elements, and sets up the input/output buffers between stages in the pipeline.

The machine learning computing code is typically C-programming language based. In one embodiment, the machine learning code is written in C++ programming language. The machine learning code input to the code processing module 302 can perform machine learning using a decision tree or ensembles of decision trees. The set of processes performed by the machine learning computing code can include data mining, such as data mining for trend detection, topic extraction, fault detection or anomaly detection, and lifecycle determination. In one embodiment, the set of processes includes using fault detection to identify faults and determine the lifecycle in aircrafts or spacecrafts. The attributes for the sample data are different for different applications, but can be processed using the same decision tree learning algorithm.

One embodiment of the synthesis module 350 includes the hardware architecture specifier module 304. The hardware architecture specifier module 354 can be any combination of software agents and/or hardware modules able to determine the architecture (e.g., user specified and/or automatically determined to be, multi-core, multi-processor, computer cluster, cell, FPGA, and/or GPU) of the multi-processor environment in which the threads from the machine learning computing code are to be executed.

The instructions sets for parallel thread execution in the multi-processor environment are generated from the source code of the machine learning computing code. The architecture the multi-processor environment can be user-specified or automatically detected. The multi-processor environment may include any number of computing elements on the same processor, multiple processors, using shared memory, using distributed memory, using local memory, or connected via a network.

In one embodiment, the architecture of the multi-processor environment is a multi-core processor and the first computing element is a first core and the second computing element is a second core. In addition, the architecture of the multi-processor environment can be a networked cluster and the first computing element is a first computer and the second computing element is a second computer. In some embodiments, a particular architecture includes a combination of multi-core processors and computers connected over a network. Alternate and additional combinations are contemplated and are also considered to be within the scope of the novel art described herein.

One embodiment of the synthesis module 350 includes the resource computing module 306. The resource computing module 306 can be any combination of software agents and/or hardware modules able to compute or otherwise determine the memory and/or processing resources available for allocation to threads and processes in the multi-processor environment of any architecture or combination of architectures.

In one embodiment, the resource computing module 306 determines intensity of resource consumption of threads in the machine learning computing code. The resource computing module 306 further determines the resources available to a particular architecture of the multi-processor environment through, for example, determining processing and memory resources such as the processing speed of each processing element, size of cache, size of local or shared memory elements, speed of memory, etc.

The resource computing module 306 can then, based on the intensity of resource consumption of the threads and the available resources, determine estimated running times for threads and/or processes in the machine learning computing code for the specific architecture of the multi-processor environment. The resource computing module 306 can be coupled to the hardware architecture specifier module 304 to obtain information related to the architecture of the multi-processor environment for which instruction sets for parallel execution are to be generated.

In addition, the resource computing module 306 can determine the communication delay among computing elements in the multi-processor environment. For example, the resource computing module 360 can determine communication delay between a first computing element and a second computing element and further between the first computing element and a third computing element. The identified architecture is also used to determine the communication costs between the computing elements and any associated memory units in the multi-processor environment. In addition, the identified architecture can be determined via communications with the hardware architecture specifier module 304.

Typically, the communication delay/cost is determined during installation when benchmark tests may be performed, for example, by the resource computing module 306. For example, the latency and/or bandwidth of a network connecting the computing elements in the multi-processor environment can be determined via benchmarking. For example, the running time of a functional block can be determined by performing benchmarking tests using varying size inputs to the functional block.

The results of the benchmark tests can be stored in the resource database 380 coupled to the resource computing module 306. For example, the resource database 380 can store data comprising the resource intensity the functional blocks and communication delays/times among computing elements and memory units in the multi-processor environment.

The communication delay can include the inter-processor communication time and memory communication time. For example, the inter-processor communication time can include the time for data transmission between processors and the memory communication time can include time for data transmission between a processor and a memory unit in the multi-processor environment. In one embodiment, the communication delay, further comprises, arbitration delay for acquiring access to an interconnection network connecting the computing elements in the multi-processor environment.

One embodiment of the synthesis module 350 includes a training data partitioning module 308. The training data partitioning module 308 is any combination of software agents and/or hardware modules able to identify training data in the machine learning computing code and partition the training data.

In machine learning, the training data can be partitioned into separate sets such that the machine training performed on the separate sets and be achieved concurrently (or in parallel). The training data partitioning is, in one embodiment, user-specified or automatic. For example, the training data can be partitioned into the same number of sets as t he total number of processing elements or the number of processing elements that are available. The user provides a collection of data. Then that the collection of data is partitioned among the available processing elements based on the capability of each processing element. For example, a processor running at 2 GHz would be assigned more data than a processor running at 500 MHz.

The training data can be partitioned into multiple training data sets for performing machine learning where a training routine (e.g., a training code segment) in the machine learning code can be executed at separate threads on the two or more training data sets at partially or wholly overlapping times. The separate threads can be executed on distinct computing elements in the multi-processor environment.

One embodiment of the synthesis module 350 includes a task identifier module 310. The task identifier module 310 is any combination of software agents and/or hardware modules able to identify a set of concurrently-executable tasks from the machine learning computing code. In the C/C++ program, user annotations are analyzed to identify that tasks that can be run concurrently.

Since machine learning algorithms typically have separate tasks that can be concurrently executed, these tasks can be identified by the task identifier module 310 and assigned to different processing elements for concurrent execution. In one embodiment, the set of concurrently-executable tasks in the machine learning computing code comprises: partitioned data from splitting of a node in a decision tree. For example, after each recursive partitioning step during node spitting in machine training through decision trees, the partitioned data can be used for training in parallel. Based on a given recursive partitioning method and node-splitting method, concurrently-executable tasks can be created after each recursive partitioning.

For example, given a sequential code and data partitioned into left and right subsets:
decisionTreeTrain(left);
decisionTreeTrain(right);
   To indicate parallel execution, the user can add the annotations to those method calls, for example:
decisionTreeTrainSpawn(left);
decisionTreeTrainSpawn(right);

Using the user annotation, the synthesis module 350 can determine that the training going down the left subtree and the right subtree can be executed concurrently. One embodiment of the synthesis module 350 includes a pipelining module 312. The pipelining module 312 is any combination of software agents and/or hardware modules able to identify pipelining stages from the machine learning computing code to implement instruction pipelining.

For example, given the sequential code:
A( );
B( );
C( );
D( );
   The user can add annotations to identify the stages that can be executed in parallel:
STAGE 1:
A( );
B( );
STAGE 2:
C( );
STAGE 3:
D( ):
   The synthesis module 350 can then take these annotations, and generate parallel code with three stages, where stage 1 contains calls to A and B, stage 2 contains call to C, and stage 3 contains call to D.

Machine training computing code may include processes which can be implemented in sequential stages where each stage is associated with an individual state. The sequential stages can be identified as pipeline stages where data output from each stage is passed on to a subsequent stage. The pipeline stages can be identified by the pipelining module 312. In addition, the pipelining module 312 determines how data is passed from one stage to another depending on the specific architecture of the multi-processor environment. The data type of the output stage which is the input to another stage is matched as a part of the pipelining process and pipeline stage identification process. The data communication latency can be designed to overlap with computation time to mitigate the effect of communication costs.

One embodiment of the synthesis module 350 includes the scheduling module 314. The scheduling module 314 is any combination of software agents and/or hardware modules that assigns threads, processes, tasks, and/or pipelining stages to computing elements in a multi-processor environment.

The computing elements execute the assigned threads, processes, tasks, and/or pipelining stages concurrently to achieve parallelism in the multi-processor environment. The scheduler module 314 can utilize various inputs to assign the threads to processing elements. For example, the scheduler module 314 communicates with the resource database 380 to obtain estimate running time of the functional blocks and the communication costs for communicating between processors (e.g., via a network, shared-bus, shared memory, etc.).

During runtime, the identified concurrently-executable tasks are communicated to the scheduling module 314 such that the scheduling module 314 can dynamically assign the tasks to the processing elements. Furthermore, the scheduler module 314 assigns the pipelining stages to two or more of the computing elements in the multi-processor environment based on the architecture of the multi-processor environment. The scheduler module 314 typically further factors into consideration, the resource availability information provided by the resource database 380 in making the assignments.

One embodiment of the synthesis module 350 includes the parallel code generator module 316. The parallel code generator module 316 is any combination of software agents and/or hardware modules that generating the instruction sets to be executed in the multi-processor environment to perform the processes represented by the machine learning computing code.

The parallel code generator module 316 can, in most instances, receive instructions related to assignment of threads, processes, data, tasks, and/or pipeline stages to computing elements, for example, from the scheduling module 314. In addition, the parallel code generator module 316 is further coupled to the machine learning computing code processing module 302 to receive the sequential code for the machine learning code. The parallel code generator module 316 can thus generate instruction sets representing the original source code for parallel execution to perform function represented by the machine learning computing code. In one embodiment, the instruction sets further include instructions that govern communication and synchronization among the computing elements in the multi-processor environment.

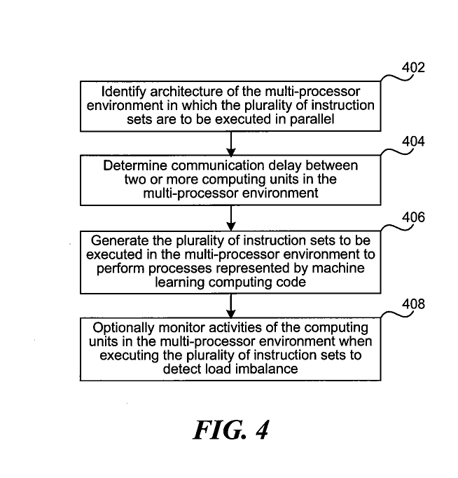

FIG. 4 depicts a flow chart illustrating an example process for generating instruction sets from machine learning computing code for parallel execution in a multi-processor environment, according to one embodiment.

In process 402, the architecture of the multi-processor environment in which the instruction sets are to be executed in parallel is identified. In some embodiments, the architecture is automatically determined without user-specification. Similarly architecture determination can be both user-specified in conjunction with system detection. In process 404, the communication delay between two or more computing element in the multi-processor environment is determined.

In process 406, the instruction sets to be executed in the multi-processor environment to perform the processes represented by the machine learning computing code are generated. In process 408, activities of the computing elements are monitored to detect load imbalance. If load imbalance is detected in process 408, the assignment of the functional blocks to processing units can be dynamically adjusted.

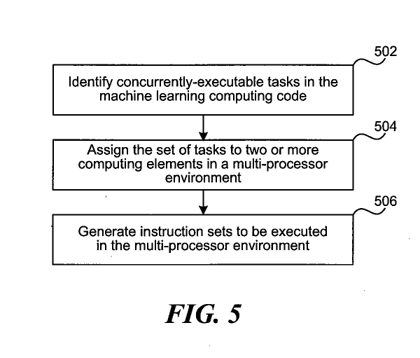

FIG. 5 depicts a flow chart illustrating an example process for generating instruction sets using concurrently-executable tasks in machine learning computing code, according to one embodiment.

In process 502, concurrently-executable tasks in the machine learning computing code are identified. In process 504, the set of tasks are assigned to two or more of the computing elements in the multi-processor environment. In process 506, instruction sets to be executed in parallel in the multi-processor environment are generated.

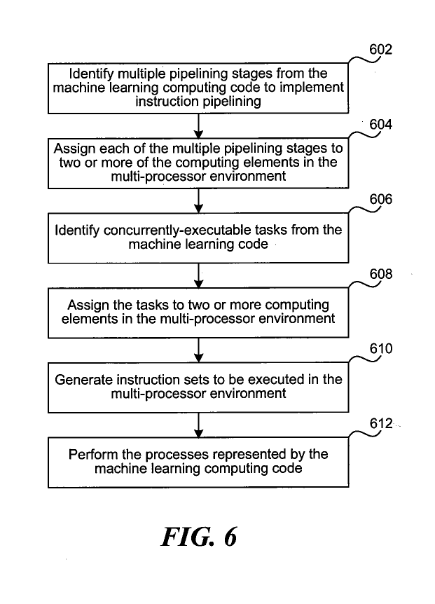

FIG. 6 depicts a flow chart illustrating an example process for generating instruction sets using pipelining stages and concurrently-executable tasks in machine learning computing code, according to one embodiment.

In process 602, multiple pipelining stages are identified from the machine learning computing code to perform instruction pipelining. In process 604, each of the multiple pipelining stages is assigned to two or more of the computing elements in the multi-processor environment. In process 606, concurrently-executable tasks are identified in the machine learning computing code. In process 608, the set of tasks are assigned to two or more of the computing elements in the multi-processor environment. In process 610, instruction sets to be executed in the multi-processor environment are generated. In process 612, the processes represented by the machine learning computing code are performed when executed.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of generating a plurality of instruction sets from machine learning computing code for parallel execution in a multi-processor environment, comprising:
partitioning training data into two or more training data sets for performing machine learning;
identifying a set of concurrently-executable tasks from the machine learning computing code;
assigning the set of tasks to two or more of the computing elements in the multi-processor environment; and
generating the plurality of instruction sets to be executed in the multi-processor environment to perform a set of processes represented by the machine learning computing code.

2. The method of claim 1, further comprising, identifying architecture of the multi-processor environment in which the plurality of instruction sets are to be executed; wherein, the architecture the multi-processor environment is user-specified or automatically detected.

3. The method of claim 2, further comprising, implementing instruction pipelining by identifying from the machine learning computing code, a plurality of pipelining stages.

4. The method of claim 3, further comprising, assigning each of the plurality of pipelining stages to two or more of the computing elements in the multi-processor environment.

5. The method of claim 4, wherein, assignment of each of the plurality of pipelining stages is based on the architecture of the multi-processor environment.

6. The method of claim 1, wherein, the machine learning computing code is C-programming language based.

7. The method of claim 1, wherein, a training code segment of the machine learning computing code is executed at separate threads on the two or more training data sets at partially or wholly overlapping times for machine learning.

8. The method of claim 7, wherein, the separate threads are executed on distinct computing elements in the multi-processor environment.

9. The method of claim 1, wherein, the machine learning computing code performs machine learning using a decision tree or ensembles of decision trees.

10. The method of claim 9, wherein, the set of concurrently-executable tasks in the machine learning computing code comprises: a set of partitioned data from splitting of a node in the decision tree.

11. The method of claim 1, further comprising, determining communication delay between the two or more computing elements in the multi-processor environment.

12. The method of claim 11, further comprising, determining the communication delay by performing a benchmarking test to determine network latency and bandwidth.

13. The method of claim 2, wherein, the architecture of the multi-processor environment is a multi-core processor and the two or more computing elements comprises a first core and a second core.

14. The method of claim 2, wherein, the architecture of the multi-processor environment is a networked cluster and the two or more computing elements comprises a first computer and a second computer.

15. The method of claim 2, wherein, the architecture of the multi-processor environment is, one or more of, a cell, a field-programmable gate array, a digital signal processing chip, and a graphical processing unit.

16. The method of claim 1, further comprising, monitoring activities of the first and second computing units in the multi-processor environment when executing the plurality of instruction sets to detect load imbalance among the two or more computing elements.

17. A system for generating a plurality of instruction sets from machine learning computing code for parallel execution in a multi-processor environment, comprising:
a training data partitioning module to partitioning training data into two or more training data sets for performing machine learning;
a concurrently-executable task identifier module to identify a set of concurrently-executable tasks in the machine learning computing code;
a pipelining module to identify, from the machine learning computing code, a plurality of pipelining stages;
a scheduling module to assigning the set of tasks to two or more of the computing elements in the multi-processor environment; and
a parallel code generator module to generate parallel code to be executed by the computing units to perform a set of functions represented by the sequential program.

18. The system of claim 17, wherein the pipelining module performs instruction pipelining by identifying from the machine learning computing code, a plurality of pipelining stages.

19. The system of claim 18, wherein, the scheduling module assigns each of the plurality of pipelining stages to two or more of the computing elements in the multi-processor environment.

20. A system for generating a plurality of instruction sets from machine learning computing code for parallel execution in a multi-processor environment, comprising:
means for, partitioning training data into two or more training data sets for performing machine learning;
means for, identifying a set of concurrently-executable tasks in the machine learning computing code;
means for, assigning the set of tasks to two or more of the computing elements in the multi-processor environment; and
means for, generating the plurality of instruction sets to be executed in the multi-processor environment to perform a set of processes represented by the machine learning computing code.

21. The system of claim 20, wherein, the set of processes comprises, data mining for trend detection.

22. The system of claim 20, wherein, the set of processes comprises, data mining for topic extraction.

23. The system of claim 20, wherein, the set of processes comprises, data mining for fault detection or anomaly detection.

24. The system of claim 21, wherein, the fault detection is used to for identifying faults in aircrafts or spacecrafts.

25. The system of claim 20, wherein, the set of processes comprises, data mining for lifecycle determination of aircrafts or spacecrafts.
